(19) United States
(12) Patent Application Publication
(10) Pub. No.: US 2010/0141594 A1
(43) Pub. Date: Jun. 10, 2010

(54) Method of inputting information using touch input device and system for performing the same

(75) Inventor: Sung Jin Kim, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/590,879

(22) Filed: Nov. 16, 2009

(30) Foreign Application Priority Data
Dec. 4, 2008 (KR) 10-2008-0122357

(51) Int. Cl. G06F 3/041

(52) U.S. Cl. 345/173

(57) ABSTRACT

A touch input device is configured to apply an information input method and system for use with a portable terminal. In the information input method and system, when a touch against the touch input device is not released, voltage generated in a resistive overlay touch screen is changed by the touch input device and various functions are performed according to the voltage change.

### CROSS-REFERENCE TO RELATED APPLICATION(S) AND CLAIM OF PRIORITY

The present application is related to and claims priority to and the benefit of Korean Patent Application No. 10-2008-0122357, filed on Dec. 4, 2008, the entire contents of which are incorporated herein by reference.

### TECHNICAL FIELD OF THE INVENTION

The present invention relates generally to a method and a system for inputting information using a touch input device and, more particularly, to a method and a system for inputting information using a touch input device that changes voltage generated on a resistive overlay touch screen using a magnetic field and performs various functions according to the voltage changes.

### BACKGROUND OF THE INVENTION

Recently, portable terminals that provide various functions, such as a mobile terminal and a Personal Digital Assistant (PDA), have become popular.

Since the portable terminals provide various functions, such as a wireless Internet function, electronic dictionary function, multimedia capture/reproduction function, game function, and so forth, in addition to a basic communication function, various input devices are needed. As the portable terminals become increasingly small and thin, a touch screen in which an input unit and a display unit are integrated into a single device is widely used in a small terminal such as the portable terminal.

There are several types of touch screen, such as a capacitive overlay touch screen, a resistive overlay touch screen, a transmitter touch screen, and an infrared beam touch screen.

Among the above-mentioned touch screens, since the resistive overlay touch screen can use various touch input devices such as a touch pen, a stylus, a hand, and the like, and has economical benefits, the resistive overlay touch screen is widely used. A portable terminal to which the resistive overlay touch screen is applied has a simple input method of confirming a touch coordinate on the touch screen and performing a function corresponding to the touch coordinate. That is, in existing portable terminals touch input may be required to be performed several times for the execution of a specific function. Therefore, a method and a system capable of easily performing a set function (for example, change of color information) without processing several touch inputs are required.

### SUMMARY OF THE INVENTION

To address the above-discussed deficiencies of the prior art, it is a primary object to provide a method and a system for inputting information using a touch input device capable of changing voltage at a position on the touch input device to be touched and performing various functions to be set according to voltage changes.

In accordance with an exemplary embodiment of the present invention, an information input system using a touch input device includes: a touch input device that changes a voltage generated on a resistive overlay touch screen by a touch; and a portable terminal that includes the resistive overlay touch screen and estimates a voltage change corresponding to a difference between a voltage changed by the touch input device and a voltage generated by the touch and performs a set function according to the estimated voltage change.

In accordance with another exemplary embodiment of the present invention, a method of inputting information using a touch input device in an information input system comprising a portable terminal including a resistive overlay touch screen and the touch input device includes: checking whether a voltage is changed when a touch is generated while the touch input device is being touched; estimating a voltage change corresponding to a difference between a changed voltage when a voltage generated by the touch is changed and a voltage generated by the touch; and performing a function set according to the voltage change.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a schematic view for an information input system using a touch input device according to an exemplary embodiment of the present invention;

FIGS. 2A and 2B illustrate views for a touch input device according to an exemplary embodiment of the present invention;

FIG. 3A illustrates a block diagram for the touch input device according to the exemplary embodiment of the present invention;

FIG. 3B illustrates a detail view of a selector of the touch input device of FIG. 3A;

FIG. 4 illustrates a block diagram for a portable terminal according to an exemplary embodiment of the present invention; and

FIG. 5 illustrates a flowchart of an information input method using a touch input device according to an exemplary embodiment of the present invention.

### DETAILED DESCRIPTION OF THE INVENTION

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal.

The exemplary embodiments of the present invention are provided for the easy description and understanding of the present invention with specific examples but do not limit the scope of the present invention. It will be appreciated by those skilled in the art that various changes and modifications may be practiced without departing from the spirit of the present invention.

In this application, the term “touch input device” indicates an input device for inputting coordinate information through a touch screen. The touch input device can be a stylus, a touch pen, and the like. Particularly, in the embodiment of the present invention, the touch input device can generate a magnetic field.

FIG. 1 illustrates a schematic view for an information input system using a touch input device according to an exemplary embodiment of the present invention.

Before the detailed description, for the purpose of convenient description, an example in which color information to be displayed on a touch screen is selected using the touch input device will be described.

Referring to FIG. 1, an information input system using a touch input device according to an exemplary embodiment of the present invention includes a touch input device 300 and a portable terminal 100 that includes a resistive overlay touch screen 130.

The touch input device 300 can be a stylus as a pen-type input tool. The touch input device 300 according to the exemplary embodiment of the present invention can input color information to be displayed. More particularly, the touch input device 300 can include a selector 320 that can select color information and a magnetic field generator that generates a magnetic field.

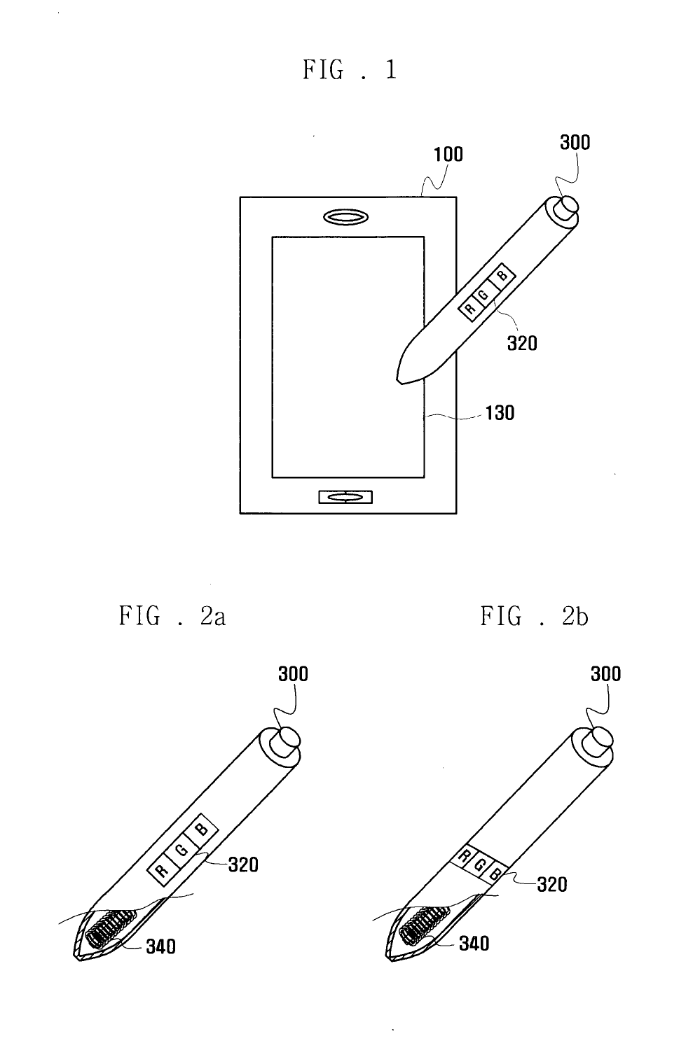

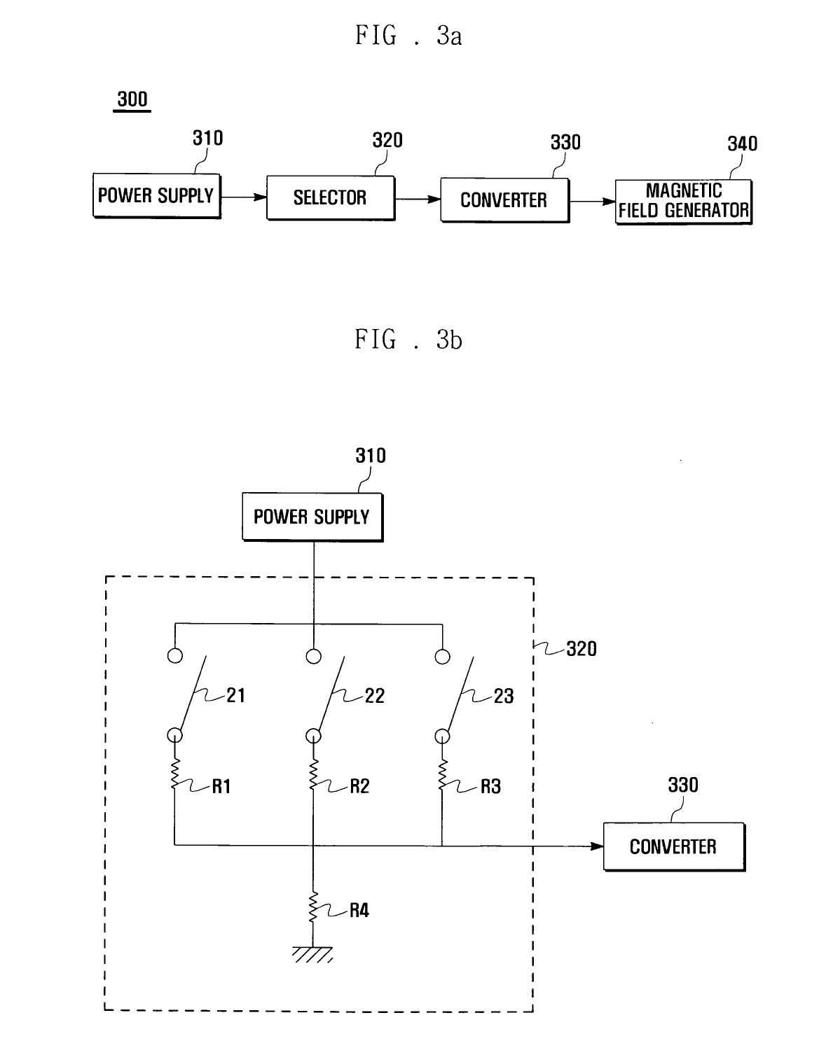

The touch input device 300 can generate a magnetic field. In this example, voltage of the touch screen 130 generated by touching the touch input device 300 can be changed by the magnetic field such that, due to the changed voltage, the portable terminal 100 can recognize the information selected by the selector 320. The voltage is changed by the magnetic field since the change of the magnetic field induces electric current according to Maxwell's equations and the induced current changes the voltage. The touch input device 300 will be described with reference to FIGS. 2A to 3B, herein below.

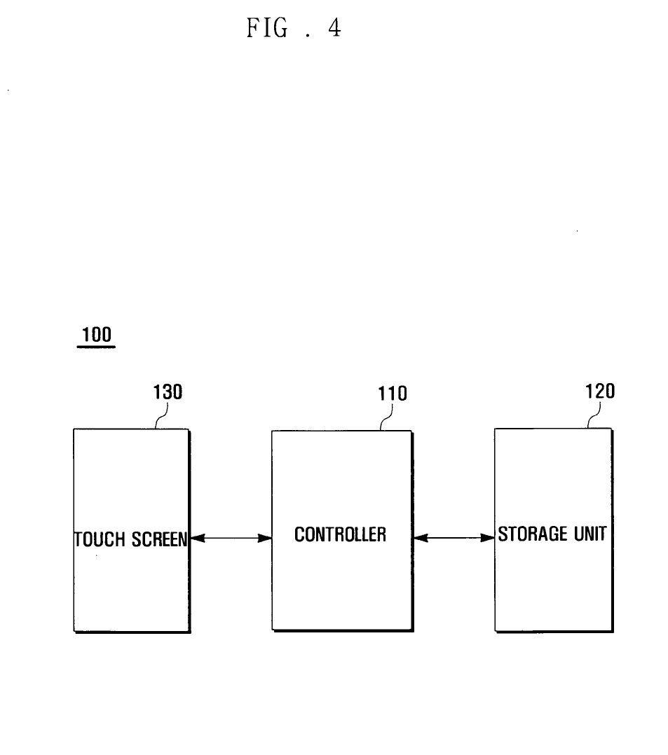

The portable terminal 100 includes a resistive overlay touch screen 130 that can recognize coordinates through voltages of X- and Y-axes and can perform functions selected by a user. In the exemplary embodiment of the present invention, the portable terminal 100 can recognize color information selected in the touch input device 300 by the user. More particularly, when voltage generated by touching the touch input device 300 and voltage generated by maintaining the touch are changed, the portable terminal 100 can check the voltage changes and can determine the color information selected in the touch input device 300. The portable terminal 100 will be described with reference to FIG. 4, herein below.

Herein above, respective components of the information input system according to an exemplary embodiment of the present invention have been described. Hereinafter, the respective components of the information input system according to the exemplary embodiment of the present invention will be described in detail.

FIGS. 2A and 2B illustrate views for a touch input device according to an exemplary embodiment of the present invention.

Referring to FIGS. 2A and 2B, the touch input device 300 can be a pen type. The touch input device 300 can include a selector 320, mounted on an outer side of the touch input device 300, that can select color information and a magnetic field generator 340, installed inside the touch input device 300, that can generate a magnetic field according to the selected color information.

The selector 320 can be a device that changes intensity of a magnetic field according to the color information and can include a plurality of switches. In the selector 320, the switches can be arranged in the longitudinal direction as illustrated in FIG. 2A, or in the lateral direction as illustrated in FIG. 2B. The switches can be turned on when pressure is applied thereto and can be turned off when the pressure is released.

The selector 320 is not limited to the above-mentioned configuration. That is, the selector 320 can be a touch sensor, a contact sensor, and the like. The position of the selector 320 is not limited to the positions as illustrated in FIGS. 2A to 2B. That is, the selector 320 can be freely mounted at various positions by a designer in consideration of user convenience.

The magnetic field generator 340 is a device that can generate a magnetic field when current is supplied and can be an electromagnet such as a solenoid in which a coil is wound around a cylindrical iron core. The magnetic field generator 340 can vary the intensity of the magnetic field under the control of the selector 320. The selector 320 and the magnetic field generator 340 will be described in detail with reference to FIGS. 3A and 3B, herein below.

Herein above, an outer appearance of the touch input device 300 according to the exemplary embodiment of the present invention has been described. Hereinafter, configuration of the touch input device 300 will be described.

FIG. 3A is a block diagram illustrating the touch input device 300 according to the exemplary embodiment of the present invention. FIG. 3B is a detail view of the selector of the touch input device 300 of FIG. 3A.

Referring to FIGS. 3A and 3B, the touch input device 300 according to the exemplary embodiment of the present invention can include a power supply 310, the selector 320, a converter 330, and the magnetic field generator 340.

The power supply 310 is a device for supplying electric power and can be a battery, a rechargeable battery, a solar battery, and the like. Although not illustrated, the power supply 310 can include an ON/OFF device such as a switch.

The selector 320, as described above, selects the color information. The color information can be plural. The selector 320 can vary the magnitude of an output voltage fed to the converter 330 according to a color selected by the user. The selector 320, as illustrated in FIG. 3B, can include a first resistor R1, a second resistor R2, a third resistor R3, a fourth resistor R4, a first switch 21, a second switch 22, and a third switch 23.

The power supply 310 can be connected to an end of each of the first to third switches 21 to 23. In this example, the other end of the first switch 21 can be connected to an end of the first resistor R1, the other end of the second switch 22 can be connected to an end of the second resistor R2, and the other end of the third switch 23 can be connected to an end of the third resistor 23. The other ends of the first to third resistors R1, R2, and R3 can be connected to the end of the fourth resistor R4 and the converter 330. The other end of the fourth resistor R4 can be connected to ground.

The first to third resistors, R1, R2, and R3 can have different resistances. This configuration can make voltages output according to the color selected by the user be different from each other. That is, the selector 320 can activate any one of the first to third switches 21 to 23 according to the user's choice. An output voltage from the selector 320 differs according to the activated switch and resistance of the connected resistor.

The converter 330 is a device for converting DC voltage into AC voltage and can convert the output voltage from the selector 320 to AC voltage. The converted AC voltage can be applied to the magnetic field generator 340.

The magnetic field generator 340 receives AC voltage from the converter 330, generates a magnetic field and can be an electromagnet such as solenoid in which a coil is wound around a cylindrical iron core. The magnetic field generator 340 can generate magnetic fields of different intensities according to the selected color information. The voltage change generated on the touch screen can differ according to the intensity of the magnetic field and the portable terminal can determine the color information selected by the touch input device 300.

Although not illustrated, the touch input device 300 can further include an amplifier to amplify the AC voltage. The amplifier amplifies the AC voltage to increase the intensity of the magnetic field generated by the magnetic field generator 340 so that the voltage change generated in the touch screen by the magnetic field can be increased.

As described above, the touch input device 300 varies the magnitude of the DC voltage through the selector 320 and converts the DC voltage into AC voltage through the converter 330, but is not limited thereto. For example, the touch input device 300 can be configured by interchanging positions of the converter 330 and the selector 320 such that the converter 330 can convert DC voltage into AC voltage and the selector 320 can vary the magnitude of the AC voltage.

Hereinafter, the portable terminal 100 will be described.

FIG. 4 illustrates a block diagram for the portable terminal according to an exemplary embodiment of the present invention.

Referring to FIG. 4, the portable terminal 100 according to an exemplary embodiment of the present invention includes a controller 110, a storage unit 120, and a touch screen 130.

The touch screen 130 is a resistive overlay touch screen to check voltage when a touch is detected and to recognize a coordinate. The touch screen 130 can include a display unit configured to display various information related to status and operation of the portable terminal 100 and a touch panel configured to recognize a touch.

The display unit can be a liquid crystal display (LCD), an organic light emitting diode (OLED) display, and the like. The display unit employed in the present invention can display characters and pictures in specific colors according to the voltage change by the touch input device 300.

The touch panel is a resistive overlay touch panel to check voltages of X- and Y-axes generated by a touch and to recognize a coordinate of a touched position. Since a method of recognizing a touch in the resistive overlay touch panel is well known to those skilled in the art, a description thereof will be omitted.

In the touch panel, the voltage at the position touched by the magnetic field generated in the touch input device 300 can be changed. In this case, the touch panel can feed the voltage changed by the magnetic field to the controller 110. The changed voltage fed to the controller 110 can be any one of voltages of X- and Y-axes.

The controller 110 can control overall operation of the portable terminal 100 and signal flows between internal blocks of the portable terminal 100 and can perform data processing. The controller 110 can determine the color information according to the voltage change generated by the touch input device 300. More particularly, the controller 110 can compare voltage generated when a touch is detected with voltage changed by the magnetic field that is generated in the touch input device 300 to estimate a voltage change and can determine color information that the user wishes to input according to the estimated voltage change. To this end, the storage unit 120 can store color information according to the voltage change.

The storage unit 120 can store various application programs required for performing functions of the portable terminal 100 and data created when functions of the portable terminal 100 are processed. The storage unit 120 can store color information according to the voltage change generated by the touch input device 300. For example, the color information according to the voltage changes can be stored as listed in the following table 1.

TABLE 1

| Color information | Voltage change |
|---|---|
| Red | 1 V |
| Green | 2 V |
| Blue | 3 V |

Table 1 is a color information mapping table according to the voltage changes.

Referring to Table 1, the controller 110 can determine that the color red is selected when the voltage change generated by the touch input device 300 is 1 V, that the color green is selected when the voltage change is 2 V, and that the color blue is selected when the voltage change is 3 V. In Table 1, the storage unit 120 can store three-color information, but the present invention is not limited thereto. In other words, the storage unit 120 can store a plurality of color information. The color information and the mapped voltage changes do not limit the present invention. The color information and the mapped voltage changes can be set to various types and values by a designer. Moreover, the touch input device 300 inputs the color information, but the present invention is not limited thereto. That is, the present invention can be designed to perform various functions such as selection of font, font style, and font size using the touch input device 300.

Hereinafter, a method of inputting information using a touch input device according to an exemplary embodiment of the present invention will be described.

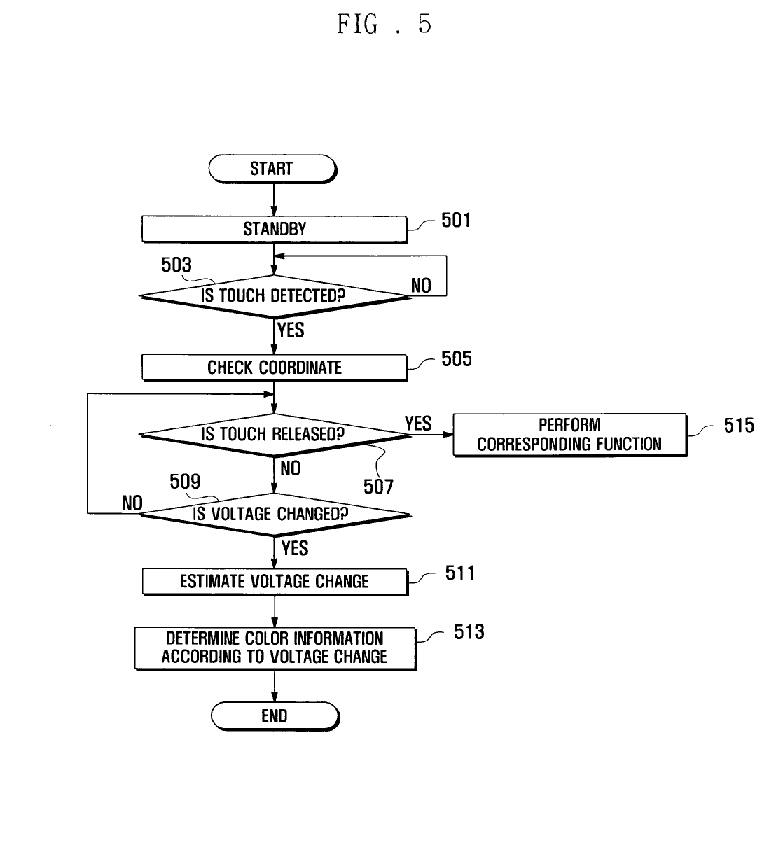

FIG. 5 illustrates a flowchart of an information input method using a touch input device according to an exemplary embodiment of the present invention.

Referring to FIG. 5, the portable terminal 100 can be in standby (block 501). Then, the controller 110 can determine whether a touch is detected (block 503). When a touch is not detected (block 503), the controller 110 can continue determining whether a touch is detected (block 503). When a touch is detected (block 503), the controller 110 can determine a coordinate of the touched position (block 505). As described above, the controller 110 can determine the touched position from the voltage of an X-axis and the voltage of a Y-axis. In this case, the controller 110 can store any one of the voltages of X- and Y-axes temporally.

Next, the controller 110 can determine whether the touch is released (block 507). When the touch is released (block 507), the controller 110 can proceed to block 515 to perform a corresponding function. For example, when a music play menu is mapped to a region from which the touch is released, the controller 110 can perform the music play function.

Alternatively, when the touch is not released (block 507), the controller 110 can determine whether at least one of the voltages of X- and Y-axes at the touched position is changed (block 509). The voltages of X- and Y-axes are changed by the magnetic field generated from the touch input device 300 and the voltage changes differ according to intensity of the magnetic field. The intensity of the magnetic field is varied by a function (for example, color) selected through the selector 320) of the touch input device 300 by a user.

When the voltages are not changed (block 509), the controller 110 determines whether the touch is released again (block 507). When the voltages are changed (block 509), the controller 110 can estimate the voltage change (block 511). The voltage change is a difference between the changed voltage and the voltage generated by the touch.

The controller 110 can determine the color information selected by the user with reference to the color information mapping table dependant on the voltage changes that is stored in the storage unit 120 (block 513). Then, the controller 110 can control the display unit to display characters or images in the selected color.

Although the voltage change of X- or Y-axes is checked while the touch is maintained, the present invention can be designed such that, in order to distinguish voltage changes by a touch input (flick) in which acceleration at the touched position is greater than a preset critical value when the touch is released and a touch input (drag) in which acceleration at the touched position is less than the preset critical value when the touch is released from the voltage change by the touch input device, minimal voltage change of X- or Y-axes by the touch input device is greater than maximal voltage change of X- or Y-axes by the drag and flick operations. For example, in the exemplary embodiment of the present invention, when the maximal voltage change of X- and Y-axes by the drag and the flick is 2 V, the minimal voltage change by the touch input device can be set to 2.5 V.

Moreover, although the color information is input using the touch input device, the present invention is not limited thereto. For example, in the method of inputting information using a touch input device, various information such as font, font size, and font style can be input.

In the above description, the voltage change has a specific value, but the present invention is not limited to the specific voltage change. That is, the voltage change can be set in a preset range.

As described above, according to the method and the system of inputting information using a touch input device, various functions such as change of color, change of font size, and the like can be easily performed without several steps of inputting information so that user convenience can be enhanced. Moreover, when opening a document or viewing a web site over the Internet, a user selects a specific color using a touch input device and drags the selected color to easily highlight a desired position.

Exemplary embodiments of the method and the system of inputting information using a touch input device have been described throughout the specification with reference to the accompanying drawings in detail and particular terms have been defined to describe the invention in the best manner. Accordingly, the meaning of specific terms or words used in the specification and the claims should not be limited to the literal or commonly employed sense, but should be construed in accordance with the spirit of the invention. Therefore, it will be understood by those skilled in the art that various changes or modifications of the embodiments are possible without departing from the spirit and scope of the invention as defined by the appended claims.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for inputting information using a touch input device in an information input system comprising a portable terminal including a resistive overlay touch screen and the touch input device, the method comprising:
checking whether a voltage is changed when a touch is generated while the touch input device is being touched;
estimating a voltage change corresponding to a difference between the changed voltage and a voltage generated by the touch; and
performing a function set according to the estimated voltage change.

2. The method of claim 1, wherein performing the set function comprises selecting any one of: color information, font, font size, and font style.

3. The method of claim 1, wherein the voltage generated by the touch is changed according to intensity of a magnetic field that is generated from the touch input device.

4. The method of claim 1, wherein checking whether the voltage generated by the touch is changed comprises checking whether at least one of voltages of an X-axis and a Y-axis for checking a coordinate of a touched position is changed.

5. An information input system using a touch input device comprising:
a touch input device configured to change a voltage generated on a resistive overlay touch screen, the voltage generated by a touching of the touch input device; and
a portable terminal comprising the resistive overlay touch screen, the portable terminal configured to estimate a voltage change corresponding to a difference between a voltage changed by the touch input device and the voltage generated by the touch, and wherein the portable terminal performs a set function according to the estimated voltage change.

6. The information input system of claim 5, wherein the touch input device comprises:
a power supply configured to provide DC power;
a selector configured to select at least one piece of information and output an output voltage according to the selected piece of information;
a converter configured to convert the output voltage into AC voltage; and
a magnetic field generator configured to receive the AC voltage from the converter and generate a magnetic field.

7. The information input system of claim 6, wherein the magnetic field generator comprises an electromagnet configured to generate the magnetic field when the AC voltage is applied.

8. The information input system of claim 7, wherein the electromagnet comprises a solenoid in which a coil is wound around an iron core.

9. The information input system of claim 6, wherein the touch input device further comprises an amplifier configured to amplify the AC voltage output from the converter to increase intensity of the magnetic field generated by the magnetic field generator such that the voltage change generated from the touch screen by the magnetic field is increased.

10. The information input system of claim 5, wherein
the touch screen is configured such that a voltage at a touched position on the touch screen is changed by a magnetic field generated by the touch input device; and wherein the portable terminal comprises:
a controller configured to estimate a voltage change corresponding to a difference between the changed voltage and the voltage generated by the touch, wherein the controller further is configured to perform a set function according to the estimated voltage change.

11. The information input system of claim 10, wherein the portable terminal further comprises a storage unit configured to map the voltage change and a specific function to store the voltage change in the storage unit.

12. The information input system of claim 10, wherein the controller changes at least one of: color information, a font, a font size, and a font style according to the voltage change.

13. The information input system of claim 10, wherein the controller estimates the voltage change from at least one of voltage of an X-axis and a Y-axis of the touch screen.

14. A portable terminal comprising:
a resistive overlay touch screen; and
a controller configured to estimate a voltage change corresponding to a difference between a voltage changed by a touch input device and the voltage generated by a touch of the touch input device, and perform a set function according to the estimated voltage change.

15. The portable terminal of claim 14, wherein the voltage generated on a resistive overlay touch screen is generated by the touching of the touch input device.

16. The portable terminal of claim 14, wherein the portable terminal further comprises a storage unit configured to map the voltage change and a specific function to store the voltage change in the storage unit.

17. The portable terminal of claim 14, wherein the controller changes at least one of: color information, a font, a font size, and a font style according to the voltage change.

18. The portable terminal of claim 14, wherein the controller estimates the voltage change from at least one of voltage of an X-axis and a Y-axis of the touch screen.

19. The portable terminal of claim 15, wherein the generated voltage at a touched position on the touch screen is changed by a magnetic field generated by the touch input device.

20. The portable terminal of claim 19, wherein the touch input device further comprises an amplifier configured to amplify an AC voltage output from a converter located in the touch input device, the amplifier configured to increase intensity of the magnetic field generated by the magnetic field generator such that the voltage change generated from the touch screen by the magnetic field is increased.
